(19) United States
(12) Patent Application Publication
(10) Pub. No.: US 2009/0123794 A1
(43) Pub. Date: May 14, 2009

(54) FUEL CELL CIRCULATION SYSTEM AND FLUID MANAGEMENT METHOD AND SHUTDOWN PROCEDURE THEREFOR

(76) Inventors: Ching-Po LEE, Hsinchu City (TW); Jin-Shu Huang, Hsinchu City (TW); Cheng Wang, Hsinchu City (TW); Nien-Hui Hsu, Hsinchu City (TW)

Correspondence Address: Muncy, Geissler, Olds & Lowe, PLLC, P.O. BOX 1364, FAIRFAX, VA, 22038-1364, US

(21) Appl. No.: 12/195,099

(22) Filed: Aug. 20, 2008

(30) Foreign Application Priority Data
Nov. 14, 2007 (TW) 096142944

(51) Int. Cl. H01M 8/04; H01M 8/06

(52) U.S. Cl. 429/14; 429/19; 429/22

(57) ABSTRACT

A fuel cell circulation system includes a fuel tank, a water tank, a mixing tank, a first pump, a second pump, and an on/off valve. The mixing tank is in fluid communication with the fuel tank and the water tank. The first pump in fluid communication with the fuel tank, the water tank and the mixing tank is for pumping the fuel in the fuel tank and the reaction water in the water tank into the mixing tank to form a mixed fluid. The second pump in fluid communication with the fuel cell and the mixing tank is used for cyclically pumping the mixed fluid to the fuel cell and sending the reacted mixed fluid back to the mixing tank. The on/off valve is provided on the flow path between the fuel tank and the first pump to control the fluid communication between the fuel tank and the mixing tank.

### CROSS REFERENCE TO RELATED APPLICATION

This application claims priority of application No. 096142944 filed in Taiwan R.O.C on Nov. 14, 2007 under 35 U.S.C. §119; the entire contents of which are hereby incorporated by reference.

### FIELD OF THE INVENTION

The invention relates to a fuel cell circulation system and its fluid management method, particularly to a fuel cell circulation system and its fluid management method capable of facilitating miniaturization and preventing water leakage.

### DESCRIPTION OF THE RELATED ART

A fuel cell has advantages of high efficiency, low noise and pollution-free and thus is a popular fuel technology conforming to the trend of environmental protection. The most commonly seen fuel cell is a PEMFC (proton exchange membrane fuel cell) or a DMFC (direct methanol fuel cell). Taking the DMFC as an example, a fuel (methanol solution) reacts with a catalyst at the anode side to produce hydrogen ions and electrons, with the electrons being transported to the cathode side via a circuit and the hydrogen ions penetrating through a proton exchange membrane to react with oxygen and the electrons to produce reaction water at the cathode side. During the operation of the DMFC, the concentration of the methanol solution supplied to the anode side of the DMFC should maintain at an allowable range, such as 5%-10%. Specifically, a methanol concentration of lower than 5% may result in insufficient fuel supply; in contrast, a methanol concentration of higher than 10% may cause excess methanol to penetrate through a membrane electrode assembly (MEA) and arrive at the cathode side. Each of them deteriorates the performance of a fuel cell. In addition, the reaction water produced at the cathode side may be recycled to mix with the highly-concentrated methanol to achieve the allowable range of the concentration, thus improving the utilization efficiency of fuels.

FIG. 1 shows a schematic diagram illustrating a conventional fuel cell circulation system 100 used for controlling the fuel concentration and recycling reaction water, where the solid lines indicate the anode circulation of a fuel cell 102, and the dash lines indicate the cathode circulation of the fuel cell 102. Referring to FIG. 1, the oxygen consumed at the cathode side of the fuel cell 102 is introduced by a blower 104, and the reaction water produced at the cathode side, having evaporated and then condensed, is stored in a water tank 106. Further, a circulation pump 108 pumps the fuel in a mixing tank 112 to the anode side of the fuel cell 102, and the residue of fuel after reaction is transported back to the mixing tank 112. During the operation of the fuel cell 102, the reaction occurred at the anode side continuously consumes the fuel of methanol, so the concentration of a methanol solution stored in the mixing tank 112 decreases over time. In that case, reaction water stored in the water tank 106 and highly-concentrated methanol stored in the fuel tank 118 are both supplied to the mixing tank 112 to maintain an allowable range of concentration of the methanol solution in the mixing tank 112. Hence, when the concentration of the methanol solution stored in the mixing tank 112 decreases, a water pump 114 and a dosing pump 116 are used for respectively sending water and methanol to the mixing tank 112 to have the methanol concentration recover to an allowable value. However, in the above conventional design, two different pumps (water pump 114 and dosing pump 116) are needed to recycle water and supply highly-concentrated methanol. This may enhance the fabrication cost, increase the occupied space, and reduce the possibility of miniaturization for the circulation system 100.

FIG. 2 shows a schematic diagram illustrating another conventional fuel cell circulation system 200, where the solid lines indicate the anode circulation of a fuel cell 202, and the dash lines indicate the cathode circulation of the fuel cell 202. Referring to FIG. 2, the oxygen consumed at the cathode side of the fuel cell 202 is introduced by a blower 204, and the reaction water produced at the cathode side, having evaporated and then condensed, is stored in a water tank 206.

Further, a circulation pump 208 pumps the fuel in a mixing tank 212 to an anode side of the fuel cell 202, and the residue of fuel after reaction is transported back to the mixing tank 212. When the concentration of the methanol solution stored in the mixing tank 212 decreases, a dosing pump 216 is used to transport highly-concentrated methanol in the fuel tank 218 into the mixing tank 212, and the reaction water in the water tank 206 is naturally dropped into the mixing tank 212 by the force of gravity.

Though in the above-mentioned conventional design the reaction water is collected by the force of gravity to enable the water pump (shown in FIG. 1) to be omitted from the fuel cell circulation system 200, such design must provide height difference for the drop of reaction water and makes the miniaturization for the circulation system 200 more difficult. Further, since the mixing tank 212 is in fluid communication with the water tank 206, the fuel at the anode side is liable to leak into the water tank 206 during the operation of the circulation pump 208.

In addition, the water tank is typically provided with an air inlet through which outside air flows to condense evaporated water. Hence, if the fuel cell circulation system is adapted for a portable device, the reaction water may leak from the air inlet of the water tank to the outside of the portable device to wet a user.

### BRIEF SUMMARY OF THE INVENTION

The invention provides a fuel cell circulation system and its fluid management method capable of reducing occupied space and fabrication cost, simplifying the fuel concentration control, and preventing water leakage.

According to an embodiment of the invention, a fuel cell circulation system, which is used for controlling the concentration of a fuel supplied to at least one fuel cell and for recycling reaction water produced by an electrochemical reaction of the fuel cell, includes a fuel tank a water tank, a mixing tank, a first pump, a second pump, and an on/off valve. The fuel tank is used for storing the fuel, the water tank is used for storing the reaction water, and the mixing tank is in fluid communication with the fuel tank and the water tank. The first pump in fluid communication with the fuel tank, the water tank and the mixing tank is used for pumping the fuel in the fuel tank and the reaction water in the water tank into the mixing tank to form a mixed fluid. The second pump in fluid communication with the fuel cell and the mixing tank is used for cyclically pumping the mixed fluid to the fuel cell to cause the electrochemical reaction and sending the reacted mixed fluid back to the mixing tank. The on/off valve is provided on the flow path between the fuel tank and the first pump to control the fluid communication between the fuel tank and the mixing tank.

In one embodiment, the flow path between the fuel tank and the first pump is merged with the flow path between the water tank and the first pump at a merged point.

In one embodiment, the flow path between the fuel tank and the first pump is separated from the flow path between the water tank and the first pump.

In one embodiment, a three-way valve in fluid communication with the fuel tank is provided on the flow path between the first pump and the mixing tank. Under the circumstance, when the fuel circulation system begins to shutdown, the first pump may pump the reaction water in the water tank into the fuel tank instead of the mixing tank to prevent the initial concentration of the methanol solution in the mixing tank from being too low for the next run of the circulation system.

In one embodiment, a three-way valve in fluid communication with the fuel cell is provided on the flow path between the first pump and the mixing tank. Under the circumstance, when the fuel circulation system begins to shutdown, the water pumped into the flow channel at the anode side of the fuel cell may force the residue of methanol to be transported to the mixing tank, so that the methanol is not left in the MEA and a wet state of the MEA is also maintained.

According to each of the embodiments above, the on/off valve provided on the flow path between the fuel tank and the first pump allows for an adjustment for the concentration of fuels in the mixing tank. Compared with the conventional design, in each of the embodiments above the water pump is no longer needed for the recycling of water, so that the occupied space, fabrication cost and power dissipation of the circulation system are all reduced. Besides, since the reaction water is not collected by the force of gravity, the height difference provided in the circulation system is no longer needed to allow for a reduced occupied space. In addition, the circulation system may operate no matter whether reaction water exists in the water tank, so the control for the fuel concentration is simplified, and additional processes, such as monitoring the fluid level in the mixing tank or the water tank, are no longer needed.

Further, since the water tank and the mixing tank are separately arranged in two sides of the first pump, the possibility that fuels leak into the water tank is eliminated.

According to another embodiment of the invention, a fluid management method for a fuel cell circulation system includes the steps of detecting the fuel concentration of the fluid in the mixing tank; pumping the fuel in the fuel tank and the reaction water in the water tank into the mixing tank by a pump when the detected fuel concentration is lower than a preset value, wherein the pump is not turned off until the fuel concentration of the fluid in the mixing tank reaches the preset value; and blocking off the flow path between the fuel tank and the mixing tank immediately after the fuel cell circulation system receives a shutdown signal, wherein the pump is turned on to pump the reaction water out of the water tank for a predetermined period of time and then turned off to remove the reaction water in the water tank.

In one embodiment, the flow path between the fuel tank and the mixing tank is blocked off, and the pump is turned on to pump the reaction water out of the water tank at regular time intervals before the reception of the shutdown signal.

In one embodiment, whether the fuel concentration of the fluid in the mixing tank continuously decreases is detected to determine the time span for pumping the reaction water out of the water tank after the reception of the shutdown signal.

In one embodiment, whether the dissipation power of the pump obviously changes is detected to determine the time span for pumping the reaction water out of the water tank when the shutdown signal is received.

According to each of the embodiments above, it is ensure that no water is allowed to leak through any opening of the water tank after the shutdown of the fuel cell circulation system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a conventional fuel cell circulation system.

FIG. 2 shows a schematic diagram illustrating another conventional fuel cell circulation system.

FIG. 3 shows a schematic diagram illustrating a fuel cell circulation system according to an embodiment of the invention.

FIG. 4 shows a schematic diagram illustrating a fuel cell circulation system according to another embodiment of the invention.

FIG. 5 shows a flowchart illustrating an embodiment of a fluid management method for a fuel cell circulation system.

FIGS. 6A and 6B show schematic diagrams illustrating another embodiment of a fuel cell circulation system, where FIG. 6A illustrates a flow control under normal operation and FIG. 6B illustrates the flow control after the reception of a shutdown signal.

FIGS. 7A and 7B show schematic diagrams illustrating another embodiment of a fuel cell circulation system, where FIG. 7A illustrates a flow control under normal operation and FIG. 7B illustrates the flow control after the reception of a shutdown signal.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

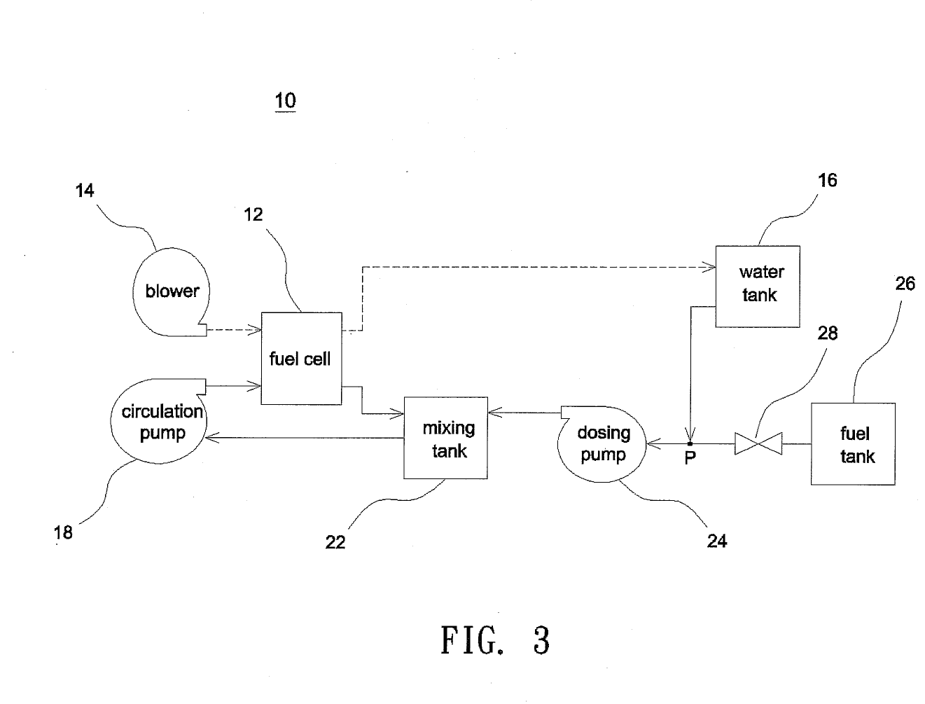

According to an embodiment of the invention, FIG. 3 shows a schematic diagram illustrating a fuel cell circulation system 10 used for controlling the concentration of fuels and recycling reaction water, where the solid lines indicate the anode circulation of a fuel cell 12, and the dash lines indicate the cathode circulation of the fuel cell 12. Referring to FIG. 3, the oxygen consumed at the cathode side of the fuel cell 12 is introduced by a blower 14, and the reaction water produced at the cathode side, having evaporated and then condensed, is stored in a water tank 16. Further, a circulation pump 18 pumps the fuel in a mixing tank 22 to the anode side of the fuel cell 12, and the residue of fuel after reaction is transported back to the mixing tank 22. During the operation of the fuel cell 12, the reaction occurred at the anode side continuously consumes the fuel of methanol, so the concentration of a methanol solution stored in the mixing tank 22 decreases over time. In that case, reaction water stored in the water tank 16 and highly-concentrated methanol stored in the fuel tank 26 are both supplied to the mixing tank 22 to maintain an allowable range of concentration of the methanol solution in the mixing tank 22. A dosing pump 24 is in fluid communication with the water tank 16, the fuel tank 26, and the mixing tank 22. In one embodiment, the flow path between the water tank 16 and the dosing pump 24 is merged with the flow path between the fuel tank 26 and the dosing pump 24 at a merged point P; in other words, both of water and highly-concentrated methanol are allowed to flow through the path between the merged point P and the dosing pump 24. Further, an on/off valve 28 is provided on the flow path between the fuel tank 26 and the merged point P. During the operation of the circulation system 10, the on/off valve 28 is turned off, so the dosing pump 24 is allowed to pump the reaction water in the water tank 16 into the mixing tank 22. Once the concentration of the methanol solution in the mixing tank 22 is detected and considered as insufficient, the on/off valve 28 is turned on to supply highly-concentrated methanol in the fuel tank 26 to the mixing tank 22, so that the concentration of the methanol solution in the mixing tank 22 may recover to the allowable range. In an alternate embodiment, the blower 14 may be replaced with an air pump.

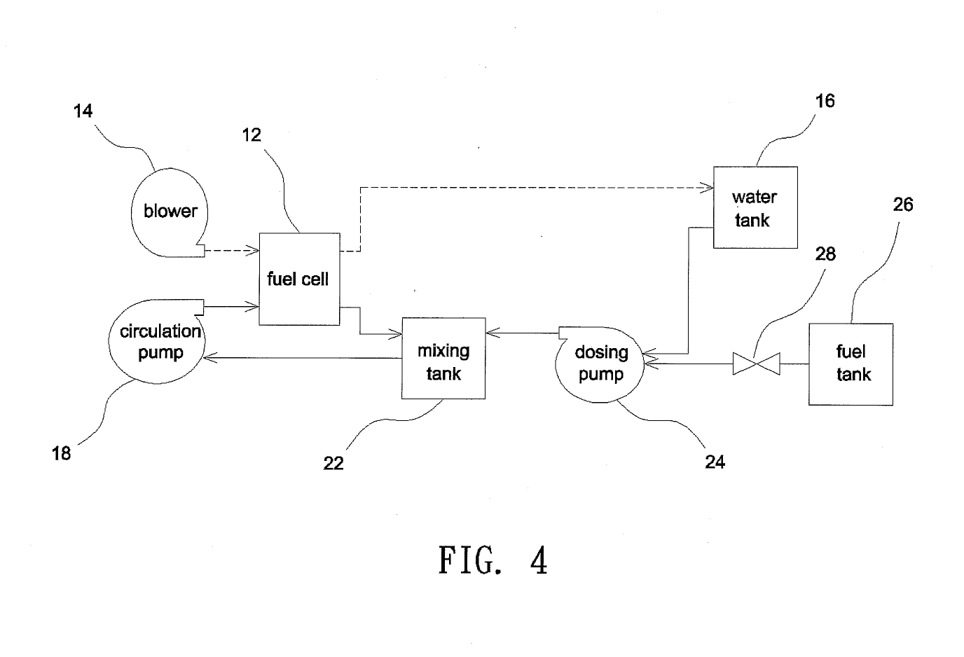

Referring to FIG. 4, in an alternate embodiment, the flow path between the fuel tank 26 and the dosing pump 24 and the flow path between the water tank 16 and the dosing pump 24 are not merged with each other, and the on/off valve 28 is provided between the flow path between the fuel tank 26 and the dosing pump 24. Such configuration provides similar effect that highly-concentrated methanol in the fuel tank 26 is supplied according to the concentration of the methanol solution in the mixing tank 22.

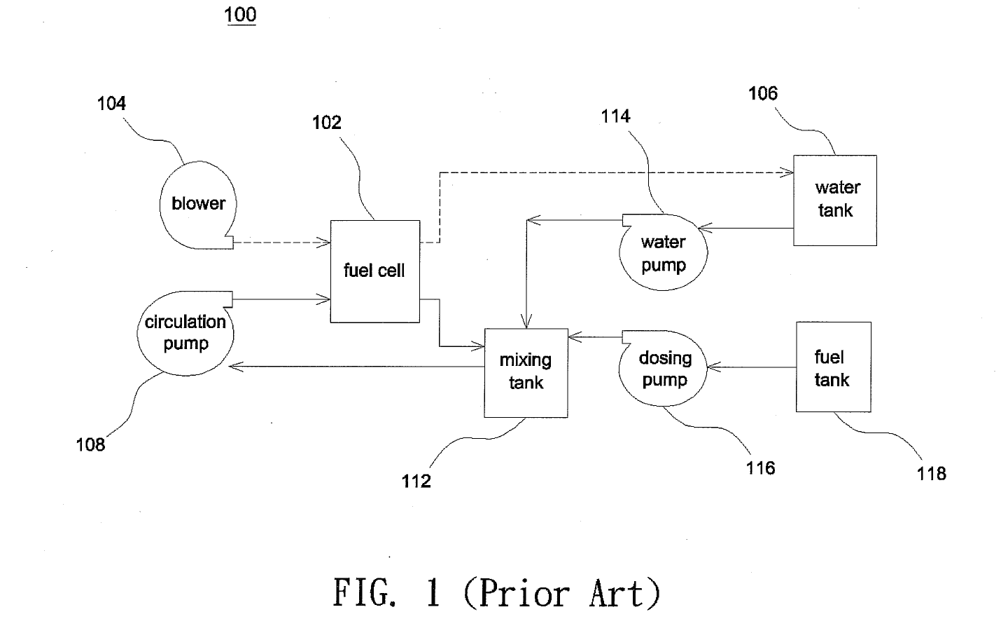

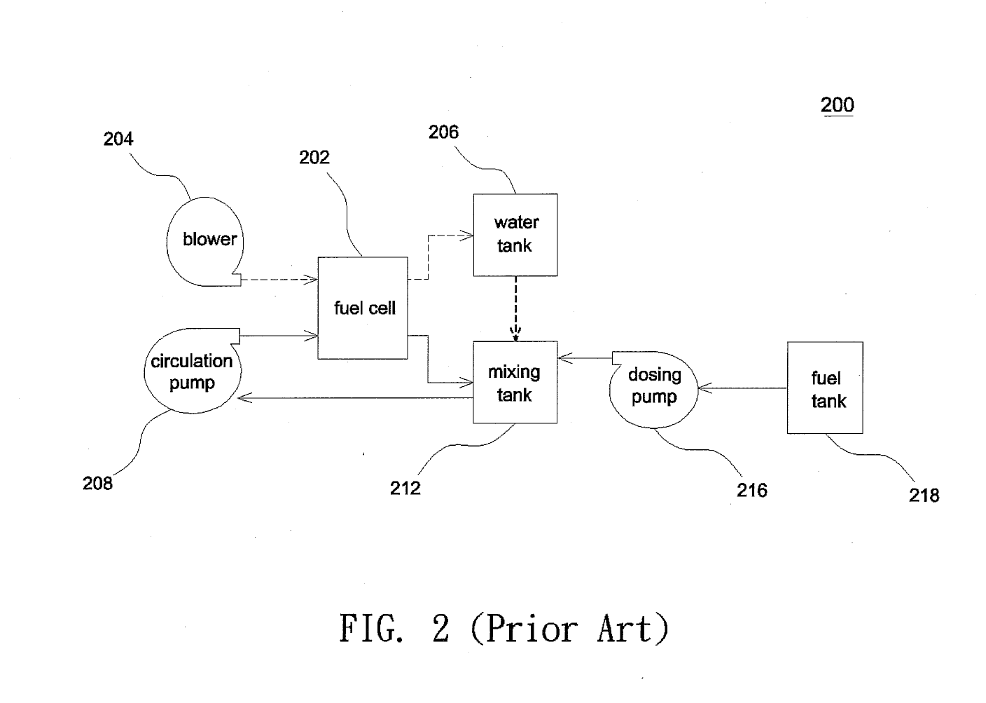

Hence, according to each of the embodiments above, it is clearly seen that the on/off valve provided on the flow path between the fuel tank 26 and the dosing pump 24 allows for an adjustment for the concentration of fuels in the mixing tank 22. Compared with the conventional design, in each of the embodiments above the water pump shown in FIG. 1 is no longer needed for the recycling of water, so that the occupied space, fabrication cost and power dissipation of the circulation system are all reduced. Further, compared with the conventional design shown in FIG. 2, in each of the embodiments above since the water tank 16 and the mixing tank 22 are separately arranged in two sides of the dosing pump 24, the possibility that fuels leak into the water tank 16 is eliminated. Besides, since the reaction water is not collected by the force of gravity, the height difference provided in the circulation system is no longer needed to allow for a reduced occupied space.

Further, since the water tank 16 and the fuel tank 26 are arranged in parallel at the inlet of the dosing pump 24 in each of the embodiments above, the circulation system may operate no matter whether reaction water exists in the water tank 16. Specifically, when the on/off valve 28 is turned on, the dosing pump 24 pumps both reaction water and highly-concentrated methanol into the mixing tank 22 as the reaction water exists in the water tank 16, or the dosing pump 24 pumps only highly-concentrated methanol into the mixing tank 22 as no reaction water exist in the water tank 16. Under the circumstance, the control for the fuel concentration is simplified, and additional processes, such as monitoring the fluid level in the mixing tank 22 or the water tank 16, are no longer needed.

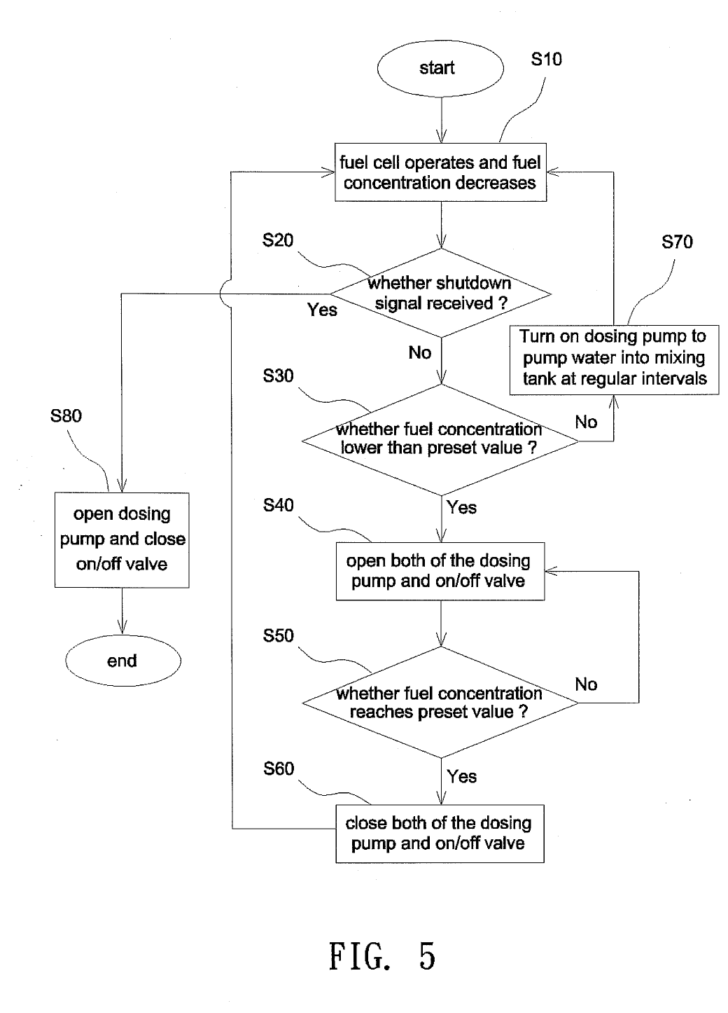

FIG. 5 shows a flowchart illustrating an embodiment of a fluid management method for a fuel cell circulation system. Referring to FIG. 5, first, when the fuel cell 12 starts operating, the concentration of the fuel in the mixing tank 22 gradually decreases (step S10). The concentration of the fuel in the mixing tank 22 is continuously detected by a device such as a concentration meter. When the detected fuel concentration is lower than a preset value, the dosing pump 24 and the on/off valve 28 are both turned on to pump water and highly-concentrated fuel to the mixing tank 22 (step S30 and step S40), and the dosing pump 24 and the on/off valve 28 are not turned off until the fuel concentration reaches the preset value. (step S50 and step S60). Repetitively performing these steps enables the concentration of the fuel in the mixing tank 22 maintain at an allowable range.

Further, in one embodiment, even the concentration of the fuel in the mixing tank 22 is not lower than the preset value and thus the dosing pump 24 and the on/off valve 28 do not need to be turned on, the dosing pump 24 still is turned on at regular time intervals while the on/off valve 28 is turned off to pump the water in the water tank 16 to the mixing tank 22 (step S70). This step S70 may ensure that the water tank 16 is kept dry to avoid the leakage of water due to overturn or other factor. Certainly, the step S70 is not necessary and should be performed according to the actual demand, and the reaction water in the water tank 16 may be transported into the mixing tank 22 as only highly-concentrated fuel is needed.

Referring to FIG. 5 again, the fuel cell circulation system 10 switches to a off mode when it receives a shutdown signal (step S20). At this time, the on/off valve 28 is turned off, but the dosing pump 24 is not turned off until all the water in the water tank 16 is pumped out. This may ensure that no water is allowed to leak through any opening (such as an air inlet) of the water tank 16 after shutdown.

In one embodiment, the dosing pump 24 may, immediately after the circulation system 10 receives a shutdown signal and the on/off valve 28 is turned off, be turned on to pump the water out of the water tank 16 for a predetermined period of time and then be turned off to ensure all water is cleaned off the water tank 16.

In an alternate embodiment, the dosing pump 24 may, immediately after the circulation system 10 receives a shutdown signal and the on/off valve 28 is turned off, be turned on to pump the water out of the water tank 16 and then be turned off as the fuel concentration reaches a fixed value. Specifically, it is clearly seen that the concentration of the fuel in the mixing tank 22 gradually decreases once water is continuously added therein, and that the fuel concentration will reach a fixed value when all the reaction water in the water tank 16 is pumped out. Thus, the concentration of the fuel in the mixing tank 22 may be monitored to recognize whether all water is cleaned off the water tank 16, and the dosing pump 24 is turned off as the fixed fuel concentration is detected.

In an alternate embodiment, the dissipation power of the dosing pump 24 is monitored to recognize whether all water in the water tank 16 is pumped out, because the dissipation power for pumping water is completely different to the dissipation power for pumping air by the dosing pump 24.

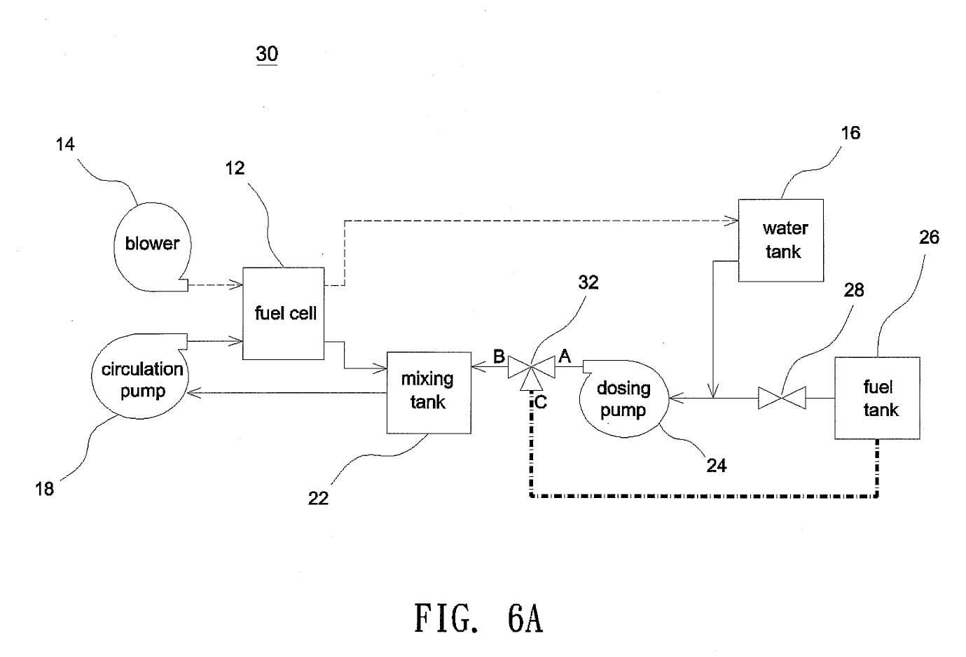

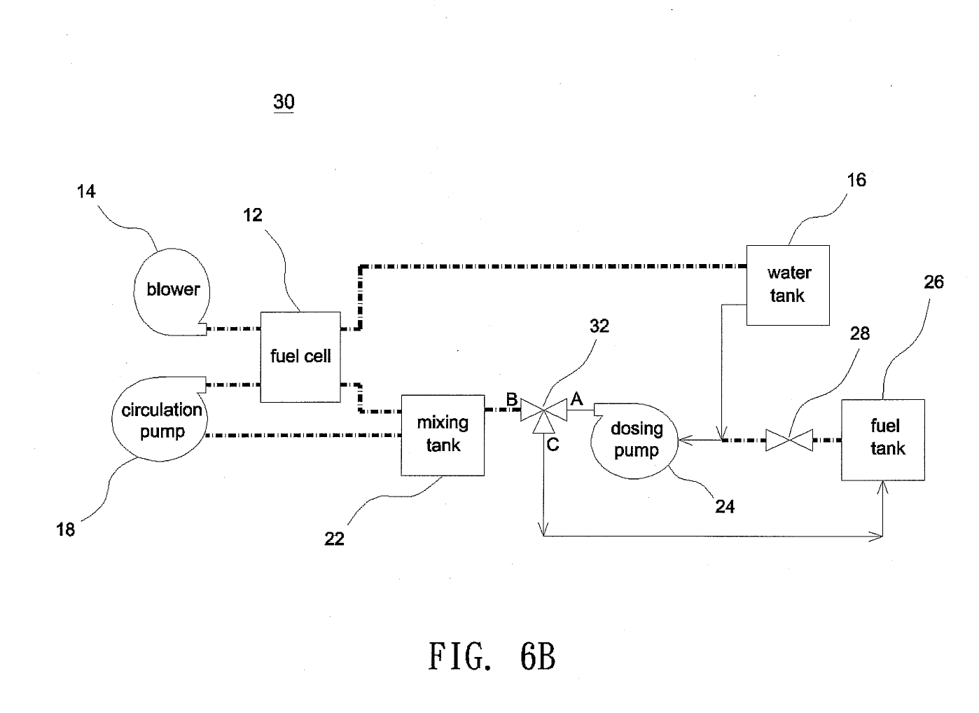

FIGS. 6A and 6B show schematic diagrams illustrating another embodiment of a fuel cell circulation system 30, where FIG. 6A illustrates the flow control under normal operation and FIG. 6B illustrates the flow control after the reception of a shutdown signal. Further, boldfaced discontinuous lines depicted in these drawings indicate the paths through which any fluid does not flow under that specific situation. The design of this embodiment is similar to that shown in FIG. 3, except a three-way valve 32 is additionally provided on the flow path between the mixing tank 22 and the dosing pump 24, and that the three-way valve 32 is in fluid communication with the fuel tank 26. Referring to FIG. 6A, under normal operation, the port A-B of the three-way valve 32 is open while its port A-C is close, so the dosing pump 24 is allowed to pump water and highly-concentrated methanol to the mixing tank 22. Referring to FIG. 6B, after the fuel cell circulation system 30 receives a shutdown signal, the on/off valve 28 is turned off, and the port A-B of the three-way valve 32 is close while its port A-C is open. Under the circumstance, the dosing pump 24 may pump the reaction water in the water tank 16 into the fuel tank 26 instead of the mixing tank 22 to prevent the initial concentration of the methanol solution in the mixing tank 22 from being too low for the next run of the circulation system 30.

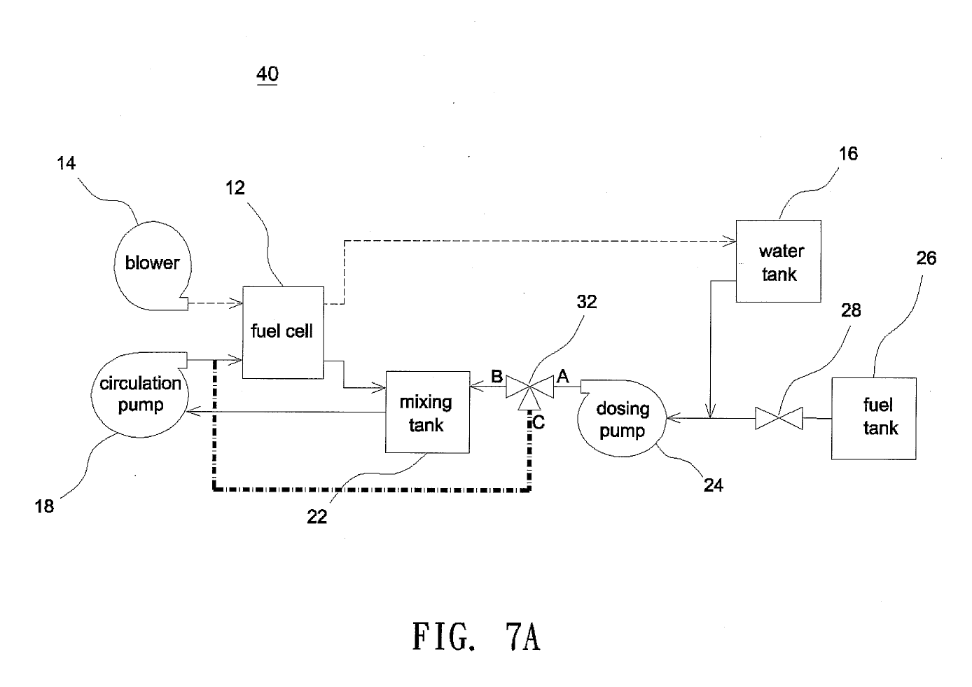

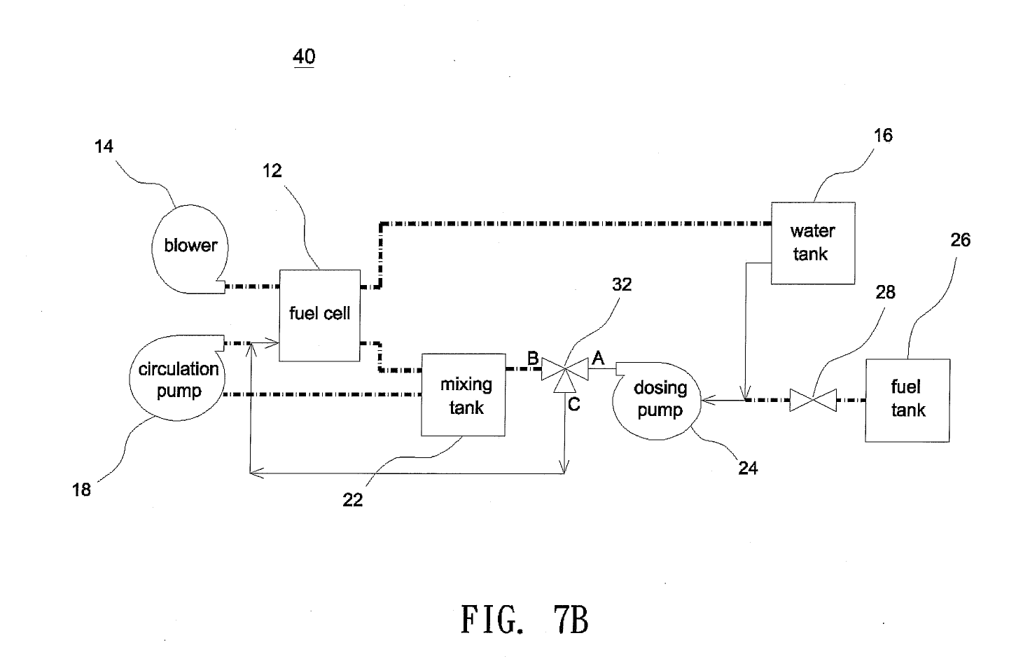

FIGS. 7A and 7B show schematic diagrams illustrating another embodiment of a fuel cell circulation system 40, where FIG. 7A illustrates the flow control under normal operation and FIG. 7B illustrates the flow control after the reception of a shutdown signal. Further, boldfaced discontinuous lines depicted in these drawings indicate the paths through which any fluid does not flow under that specific situation. The design of this embodiment is similar to that shown in FIG. 3, except a three-way valve 32 is additionally provided on the flow path between the mixing tank 22 and the dosing pump 24, and that the three-way valve 32 is in fluid communication with the fuel cell 12. Referring to FIG. 7A, under normal operation, the port A-B of the three-way valve 32 is open while its port A-C is close, so the dosing pump 24 is allowed to pump water and highly-concentrated methanol to the mixing tank 22. Referring to FIG. 7B, after the fuel cell circulation system 40 receives a shutdown signal, the on/off valve 28 is turned off, and the port A-B of the three-way valve 32 is close while its port A-C is open. Under the circumstance, the dosing pump 24 may pump the reaction water in the water tank 16 to a flow channel at the anode side of the fuel cell 12 instead of the mixing tank 22. Typically, the residue of methanol left in a membrane electrode assembly (MEA) of the fuel cell 12 after the shutdown of the fuel cell circulation system 40 may shorten the life of the MEA. Though the residue of methanol may be all removed after shutdown to cure this problem, this in turn harms the requisite wet state of the MEA. Hence, according to this embodiment, the water pumped into the flow channel at the anode side of the fuel cell 12 may force the residue of methanol to be transported to the mixing tank 22, so that the methanol is not left in the MEA and the wet state of the MEA is also maintained.

Further, though each of the embodiments above uses the methanol solution as a liquid fuel and a working fluid circulating in the circulation system, this is not limited. Instead, a variety of liquid fuels containing molecular hydrogen are available, such as light oil or ethanol solution.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the elements or component is explicitly recited in the following claims.

What is claimed is:

1. A fuel cell circulation system for controlling the concentration of a fuel supplied to at least one fuel cell and for recycling reaction water produced by an electrochemical reaction of the fuel cell, the fuel cell circulation system comprising:
a fuel tank for storing the fuel;
a water tank for storing the reaction water;
a mixing tank in fluid communication with the fuel tank and the water tank;
a first pump in fluid communication with the fuel tank, the water tank and the mixing tank for pumping the fuel in the fuel tank and the reaction water in the water tank into the mixing tank to form a mixed fluid;
a second pump in fluid communication with the fuel cell and the mixing tank for cyclically pumping the mixed fluid to the fuel cell to cause the electrochemical reaction and sending the reacted mixed fluid back to the mixing tank; and
an on/off valve provided on the flow path between the fuel tank and the first pump to control the fluid communication between the fuel tank and the mixing tank.

2. The fuel cell circulation system as claimed in claim 1, wherein the flow path between the fuel tank and the first pump is merged with the flow path between the water tank and the first pump at a merged point, and the on/off valve is provided on the flow path between the fuel tank and the merged point.

3. The fuel cell circulation system as claimed in claim 1, further comprising a blower or an air pump for transporting air required by the electrochemical reaction of the fuel cell.

4. The fuel cell circulation system as claimed in claim 1, wherein the first pump comprises a dosing pump and the second pump comprises a circulation pump.

5. The fuel cell circulation system as claimed in claim 1, further comprising a three-way valve in fluid communication with the fuel tank and provided on the flow path between the first pump and the mixing tank.

6. The fuel cell circulation system as claimed in claim 1, further comprising a three-way valve in fluid communication with the fuel cell and provided on the flow path between the first pump and the mixing tank.

7. A fluid management method for a fuel cell circulation system, the fuel cell circulation system comprising a fuel tank for storing a fuel, a water tank for storing reaction water produced by an electrochemical reaction of a fuel cell, and a mixing tank in fluid communication with the fuel tank and the water tank, the fluid management method comprising the steps of:
detecting the fuel concentration of the fluid in the mixing tank;
pumping the fuel in the fuel tank and the reaction water in the water tank into the mixing tank by a pump when the detected fuel concentration is lower than a preset value, wherein the pump is not turned off until the fuel concentration of the fluid in the mixing tank reaches the preset value; and
blocking off the flow path between the fuel tank and the mixing tank immediately after the fuel cell circulation system receives a shutdown signal, wherein the pump is turned on to pump the reaction water out of the water tank for a predetermined period of time and then turned off to remove the reaction water in the water tank.

8. The fluid management method as claimed in claim 7, wherein pumping the reaction water out of the water tank after the reception of the shutdown signal includes detecting whether the fuel concentration of the fluid in the mixing tank continuously decreases.

9. The fluid management method as claimed in claim 7, wherein pumping the reaction water out of the water tank after the reception of the shutdown signal includes detecting whether the dissipation power of the pump obviously changes.

10. The fluid management method as claimed in claim 7, wherein pumping the reaction water out of the water tank after the reception of the shutdown signal includes pumping the reaction water out of the water tank and into the mixing tank.

11. The fluid management method as claimed in claim 10, wherein blocking off the flow path between the fuel tank and the mixing tank after the reception of the shutdown signal includes turning off an on/off valve provided on the flow path between the fuel tank and the pump.

12. The fluid management method as claimed in claim 7, wherein pumping the reaction water out of the water tank after the reception of the shutdown signal includes pumping the reaction water out of the water tank and into the fuel tank.

13. The fluid management method as claimed in claim 12, wherein blocking off the flow path between the fuel tank and the mixing tank after the reception of the shutdown signal includes turning off an on/off valve provided on the flow path between the fuel tank and the pump and having a three-way valve provided on the flow path between the pump and the mixing tank be in fluid communication with the fuel tank.

14. The fluid management method as claimed in claim 7, wherein pumping the reaction water out of the water tank after the reception of the shutdown signal includes pumping the reaction water out of the water tank and into the fuel cell.

15. The fluid management method as claimed in claim 14, wherein blocking off the flow path between the fuel tank and the mixing tank after the reception of the shutdown signal includes turning off an on/off valve provided on the flow path between the fuel tank and the pump and having a three-way valve provided on the flow path between the pump and the mixing tank be in fluid communication with the fuel cell.

16. The fluid management method as claimed in claim 7, further comprising blocking off the flow path between the fuel tank and the mixing tank at regular time intervals and then turning on the pump to pump the reaction water out of the water tank before the reception of the shutdown signal.

17. A shutdown procedure for a fuel cell circulation system, the fuel cell circulation system comprising a fuel tank for storing a fuel, a water tank for storing reaction water produced by an electrochemical reaction of a fuel cell, and a mixing tank in fluid communication with the fuel tank and the water tank, and the shutdown procedure initiating immediately after the fuel cell circulation system in operation receives a shutdown signal, the shutdown procedure comprising the steps of:
turning off a second pump used for pumping the fluid in the mixing tank into the fuel cell; and
blocking off the flow path between the fuel tank and the mixing tank and turning on a first pump to pump the reaction water out of the water tank, wherein the first pump is not turned off until at least almost of the reaction water in the water tank is removed.

18. The shutdown procedure as claimed in claim 17, wherein turning on the first pump to pump the reaction water out of the water tank includes pumping the reaction water out of the water tank and into the mixing tank.

19. The shutdown procedure as claimed in claim 17, wherein turning on the first pump to pump the reaction water out of the water tank includes pumping the reaction water out of the water tank and into the fuel tank.

20. The shutdown procedure as claimed in claim 17, wherein turning on the first pump to pump the reaction water out of the water tank includes pumping the reaction water out of the water tank and into the fuel cell.
